(19) United States
(12) Patent Application Publication
(10) Pub. No.: US 2005/0259507 A1
(43) Pub. Date: Nov. 24, 2005

(54) Cast extrusion barrel with integral heat-exchangers and method for making same

(75) Inventors: Martin A. Ronkin, Salem, OR (US); Craig A. Benjamin, Lebanon, OR (US)

Correspondence Address: STOEL RIVES LLP, 900 SW FIFTH AVENUE, SUITE 2600, PORTLAND, OR, 97204-1268, US

(73) Assignee: Entek Manufacturing Inc., Lebanon, OR (US)

(21) Appl. No.: 10/853,475

(22) Filed: May 24, 2004

(51) Int. Cl. B01F 15/06; B28B 1/08

(52) U.S. Cl. 366/69; 366/149

(57) ABSTRACT

An extruder barrel segment includes an integral heat-exchanger fluid flow passageway device that is formed into a desired shape. The barrel segment is formed employing a process, such as near net shape casting or lost wax shape casting. A mold pattern is used to make a casting mold of the barrel body. The passageway device is then located into the mold and positioned to ensure that there is no interference. The mold is filled with molten metal that flows around the passageway device and encapsulates it into the barrel body. The mold gates are removed, and the casting is ready for machining.

### RELATED APPLICATIONS

Not applicable

### FEDERALLY SPONSORED RESEARCH OR DEVELOPMENT

Not applicable

### TECHNICAL FIELD

This invention relates to material extruding machines and more particularly to an extrusion screw barrel having integral heat-exchanger passageways, and a method for making same.

### BACKGROUND OF THE INVENTION

The process of extruding materials, such as polymers, is the conversion of a raw material, usually in the form of a powder or pellet, into a finished product or part by forcing the material through a die opening. Extrusion is currently the most used, and perhaps the most important, method of plastic fabrication. The extrusion process typically employs pumping a polymer at high pressure and temperature through the die opening to produce a continuous cross section or profile of the polymer.

In a continuous extrusion operation, pumping is typically performed by a screw, or combination of screws, rotating inside an elongated barrel. The polymers used are typically thermoplastics that are melted by heating the barrel and/or mechanical screw friction. Most extruded polymers have a high molecular weight and are highly viscous in the molten state. Because of the shearing action inherent in the screw feed mechanism, the process lends itself to dividing, heating, and melting the extradite material. Thermosetting polymers and elastomers can also be extruded if mixed with additives that initiate cross linking in the heated barrel, but complete the cross linking after passing through the die.

FIG. 1 shows a conventional, single screw extrusion machine 10 including a feed hopper 12 for receiving feed material 14 in the form of powder or pellets that are gravity fed onto the upper surface of a screw 16, which continuously draws feed material 14 into a barrel 18 between flights 20 of screw 16.

Barrel 18 is typically formed from multiple barrel segments 22 that are each heated by a heater element 24 to melt feed material 14. Barrel 18 is typically of constant inner diameter and has heavy walls that withstand high pressures. Barrel segments 22 extend the entire length of screw 16 from feed hopper 12 to an extrusion die 26. Typical barrel inside diameters range from about 0.75 inch (19 mm) to about 24 inches (61 cm).

The shape and rotational speed of screw 16 determines the speed and pressure at which feed material 14 moves through barrel 18. Screw 16 includes a central core 28, the diameter of which is a major factor determining the pressure on feed material 14 in barrel 18. L is the total length of screw 16, and D is the inside diameter of barrel 18. The ratio L/D is the characteristic used to describe the overall size of screw 16. Typical extrusion machines 10 have L/D ratios ranging from about 12 to about 42.

A typical plasticating, or single stage screw, has multiple processing zones. A feed, or solids conveying, zone is employed for transporting feed material 14 away from feed hopper 12 and into barrel 18. In the feed zone, feed material 14 is, in most cases, still in a solid powder or pelletized state, and screw 16 has deep flights 20 in this zone. Next, a transition zone is employed to compress and melt feed material 14 as the central core 28 diameter increases and the temperature increases from friction and the operation of heater elements 24. Finally, a metering zone is employed before extrusion die 26 to ensure that feed material 14 is sufficiently molten. In this zone the depth of flights 20 is shallow and relatively constant.

Extrusion die 26 includes an opening having the desired cross sectional shape of the product. Feed material 14 conforms to the shape of the die opening and hardens after being expelled from extrusion die 26.

There are several extrusion machine variations including twin screw extruders that may have intermeshing, non-intermeshing, co-rotating, counter-rotating, or coaxial screws. Moreover, the screw diameters can commonly range from 1.0 inches (2.5 cm) to over 6 inches (15.2 cm).

Various products may be extruded having solid, hollow, angular, cylindrical, and flat cross sections. Forming flat sheet is problematical because a small deflection in the extrusion die opening can cause large thickness variations in the final sheet. Extrusion of a film is very similar to a sheet, but the thickness variation due to deflection in the die lips has even greater importance. Since the thinner films are more flexible, the unsupported gap between the die lips must be reduced.

Considering the variability of feed materials, screws, barrel types, and processing speeds, it can be difficult to properly control the feed material temperature in the barrel and extrusion die. Depending on the feed material processing requirements, the barrel temperature might be different and require precise temperature control in each barrel segment and/or processing zone. Accordingly, barrel segments are typically fitted with both heating and cooling devices, and associated temperature controlling equipment.

Electrical resistance heating is most common with heater elements 24 typically cast in sections and attached to barrel segments 22 for uniform heat transfer. Temperature differentials in the various extruder sections are maintained using separate temperature controllers (not shown). However, a problem with this heating method is the excessive time required for heating and cooling barrel 18 for proper processing of feed material 14.

To speed up the heating and cooling time of barrel 18, prior workers have employed circulating hot oil or other heat-exchange fluids within fluid flow jackets or fluid channels machined into barrel segments 22. However, this method also has inherent disadvantages, such as thermal breakdown of the fluid by oxidation and the possibility of messy and potentially hazardous fluid leaks.

For the extrusion of certain feed materials 14, such as polystyrene, it is advisable to adjust the temperature profile of barrel 18 from about 176° C. (350° F.) at the conveying zone to about 238° C. (460° F.) at the metering zone. However, for typical heat-exchanger methods, temperature settings along barrel 18 cannot always be preset to ensure the desired melt temperature profile for feed material 14. In addition, the design and speed of screw 16 may cause excessive compression- and friction-induced heating that is typically remedied by reduced processing rates, added cooling, and screw design modifications.

The extruder barrels on extrusion machines are often liquid-cooled by employing barrel segments having machine-cored channels that circulate the cooling fluid. In the conveying zone, cooling fluid is circulated through cored passages in the associated barrel segments. Cooling in the conveying zone is necessary to prevent undue temperature rise and the possibility of melting plastic granules blocking in the hopper. Fluid circulation through cored channels is currently the most effective way of temperature controlling extruder barrels, especially for large, high-production rate extruders.

FIGS. 2A and 2B show respective end and side views of a conventional barrel segment 30. In barrel segment 30, internal heat-exchanger fluid passages 32 are machined to extend as straight lines parallel to a longitudinal axis 34 of barrel segment 30. Barrel segment 30 can be formed with two fluid passage configurations, parallel and series (referred to hereafter as “serpentine”), both of which are established by selectively plugging fluid ports 36 machined into flanges 38 at the ends of barrel segment 30. The serpentine configuration employs alternate interconnections of the fluid ports to connect straight passages to form a serpentine fluid flow direction, whereas the parallel configuration employs parallel interconnection of the fluid ports in each of flanges 38. An entrance port 40 in each of flanges 38 provides fluidic connection to fluid ports 36 and fluid passages 32.

Unfortunately, the machining steps required to manufacture such barrel segments makes them unduly expensive and subject to fluid leakage. Moreover, non-uniform temperature control of the barrel segments can lead to material processing problems.

What is needed, therefore, is an inexpensive extruder barrel segment having effective, simple to manufacture, fluid passages.

### SUMMARY OF THE INVENTION

An object of this invention is, therefore, to provide a barrel segment apparatus having integral fluid passages and a method for making same.

Another object of this invention is to provide a method of making the barrel segment apparatus by employing a net casting process.

An extruder barrel segment of this invention is employed in single- or multiple-screw extruders for processing of materials, such as plastic resins. Multiple barrel segments are typically joined together to house the extruder screw or screws. Each barrel segment includes an integral heat-exchanger system in which is formed a continuous loop of passages through which a heat-exchanging fluid passes for heating or cooling the barrel segment. The barrel segments may be formed from a single material or bimetallic material, and may be formed in one or more pieces, such as sleeved, clam shell, or solid configurations. The heat-exchanger passages of this invention are formed as integral fluid passages, eliminating the need for extensive machining.

The heat-exchanger is preferably formed as a helical tube shaped to allow maximum and uniform heat transfer while avoiding any portions of the finished barrel segment that may interfere with features required for other purposes. The tube is formed by either bending a long section of tubing or fabricating bent and straight sections of tubing together into the desired shape. To prevent crimping the tube during bending, the tube may prior to bending be filled with sand, fluid, or a wooden dowel.

The barrel segment of this invention is preferably formed by near net shape casting, which is the direct casting of metal into a nearly final shape. Of course, other casting processes may be employed, such as the lost wax process. A pattern is used to make a casting mold of the barrel body. The helical tube is then located into the mold and positioned to ensure that there is no interference. Then the mold is filled with molten metal that flows around the helical tube and encapsulates it into the barrel body. The mold gates are removed, and the casting is ready for machining.

During a relative minor machining process, the ends of the heat-exchanger passages formed by the helical tube are ported for fitting the required adaptation to the heat-exchanger fittings.

The extruder barrel segments of this invention are advantageous because the near net shaped casting reduces the weight and, therefore, the cost of material. Cost is further reduced because less material is removed by expensive machining operations.

The extruder barrel segments of this invention are further advantageous because the integral heat-exchanger passages do not require machining, are much more thermally uniform and efficient, and eliminate the need for welding or plugging to create a continuous passage. This reduces the possibility of leaks. Moreover, the heat-exchanger passages have smoothly curved corners that reduce plugging and fluid flow resistance.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a simplified pictorial cross-sectional side view of a typical prior art extrusion machine.

FIGS. 2A and 2B are simplified end and side views of a typical extruder barrel segment shown in cross-section to reveal prior art machined heat-exchanger channels.

FIG. 3 is an isometric pictorial view representing a cast barrel segment of this invention shown transparently to reveal the integral heat-exchanger coil encapsulated within the barrel segment.

FIG. 4 is an isometric pictorial view representing a heat-exchanger coil of this invention.

FIG. 5 is an isometric pictorial view representing a mold pattern used to form the extruder barrel of this invention.

FIG. 6 is an isometric pictorial view of a preferred cast barrel segment of this invention with the upper half of the barrel body cut away to reveal the heat-exchanger coil integrally encapsulated within the cast barrel body.

FIG. 7 is an isometric pictorial view of a cast barrel segment of this invention with the upper half of the barrel body cut away to reveal a first alternative embodiment in which a heat-exchanger fluid casing is integrally encapsulated within the cast barrel body.

FIG. 8 is an isometric pictorial view of a cast barrel segment of this invention with the upper half of the barrel body cut away to reveal a second alternative embodiment in which multiple heat-exchanger coils are integrally encapsulated within the cast barrel body.

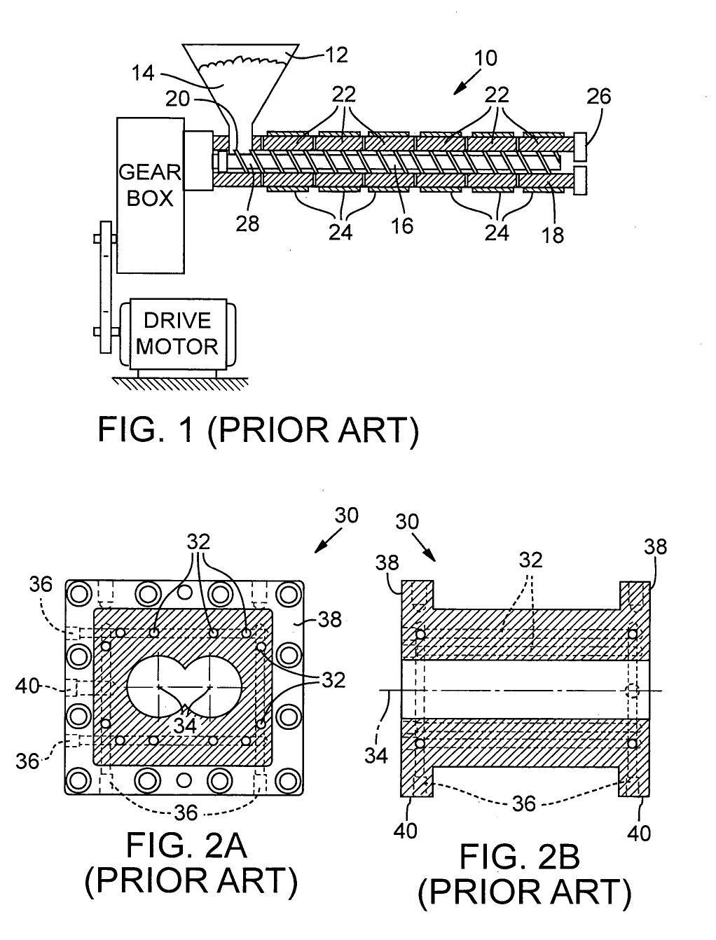

### DETAILED DESCRIPTION OF PREFERRED EMBODIMENTS

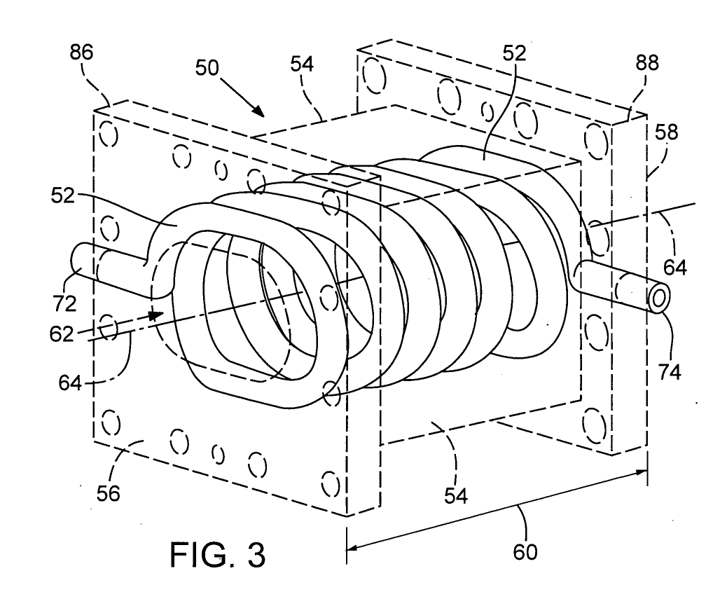

FIG. 3 shows an extruder barrel 50 (shown in phantom lines) of this invention that is formed with an integral internal fluid flow passageway 52. Extruder barrel 50 includes a barrel body 54 having first and second body end faces 56 and 58 separated by a distance 60 that defines a length of barrel body 54. First and second body end faces 56 and 58 are preferably configured as flanges to form a connectible barrel segment.

A barrel opening 62 is formed in and through barrel body 54 along a longitudinal axis 64 extending between first and second body end faces 56 and 58 (FIGS. 2A and 2B show another example as longitudinal axis 34.) Barrel opening 62 is preferably sized and shaped to receive one or multiple extruding screws (not shown) positioned substantially parallel to longitudinal axis 64. Barrel opening 62 may also receive an insert, cladding, or surface treatment to reduce corrosion, screw wear, and friction.

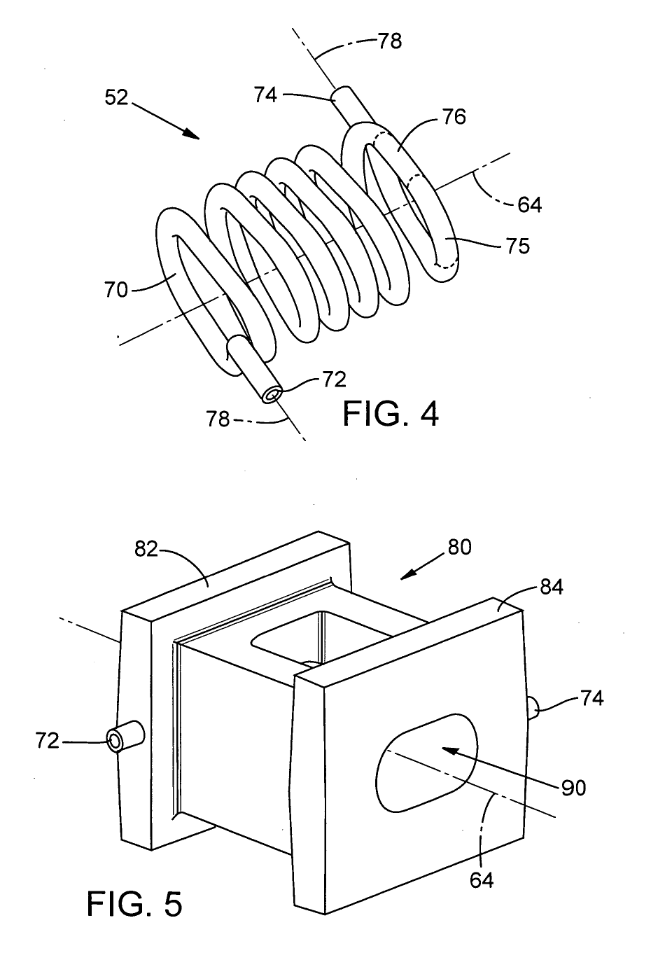

FIG. 4 shows fluid flow passageway 52, which is preferably formed as at least one helical, generally tubular coil 70 each having first and second passageway ends 72 and 74. Coil 70 defines a fluid flow pattern in the form of interconnected alternating straight and curved segments. Coil 70 is formed by either bending a long section of tubing or, for example, by fabricating bent and straight sections 75 and 76 (shown in phantom) of tubing together into a desired shape, which is not limited to a helical shape, but may include loops, serpentines, or a combination of shapes. To prevent crimping the tube during bending, the tube may prior to bending be filled with sand, fluid, or a wooden dowel. Coil 70 is preferably fabricated from steel tubing, but may be fabricated from a variety of suitable materials.

Coil 70 is encapsulated in the interior of barrel body 54 (FIG. 3). Fluid flow passageway 52 has a passageway longitudinal axis 78 that loops as a continuous spiral about longitudinal axis 64 and extends along length 60 (FIG. 3) of barrel body 54 (FIG. 3). First and second passageway ends 72 and 74 terminate at or near, respectively, first and second body end faces 56 and 58 to form entrance and exit ports of extruder barrel 54. Alternatively, coil 70 may have at least one of passageway ends 72 and 74 that terminate in barrel body 54 before reaching or extending through first or second body end faces 56 and 58.

FIG. 5 shows a casting mold 80 suitable for making extruder barrel 50 (FIG. 3) having encapsulated fluid flow passageway 52 (FIG. 3) of this invention. Extruder barrel 50 is preferably formed by near net shape casting, which is the direct casting of metal into a nearly final shape. Casting mold 80 is shaped to have an interior region corresponding to a solid interior region of extruder barrel body 54 after its formation. Before filling casting mold 80 with molten metal, coil 70 (FIG. 4) is positioned in casting mold 80 to rest in the interior region corresponding to the solid interior region of barrel body 54. The positioning of coil 70 is checked to ensure that there is no interference. Casting mold 80 is then filled with molten metal, which flows around the coil 70, thereby encapsulating it in the solid interior region of the barrel body 54. After the molten metal has solidified and sufficiently cooled, the mold gates are removed and casting mold 80 is opened to expose barrel body 54 in cast metal form.

Barrel body 54 may be formed from multiple types of cast metal, but is preferably steel and may be cast in one of a solid or a clam shell design. First and second passageway ends 72 and 74 preferably protrude from casting mold 80 prior to casting. Alternatively, ends 72 and 74 may be embedded within cast barrel body 54, thereby requiring machining of barrel body 54 to form fluid flow ports for the terminal ends of heat-exchanger coil 70. In embodiments including multiple fluid flow passageways, multiple passageway ends and ports are similarly formed.

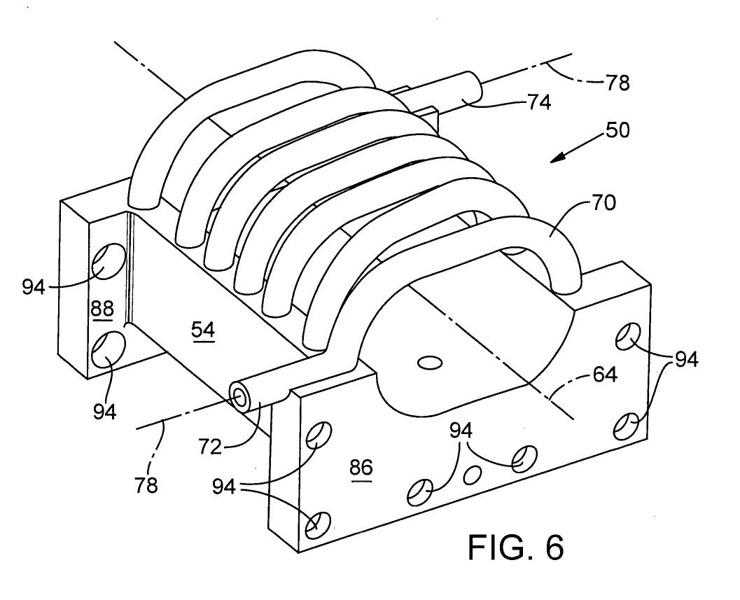

Casting mold 80 further includes cavity regions 82 and 84 for forming first and second flanges 86 and 88 (FIG. 6) that terminate in first and second body end faces 56 and 58 of barrel body 54. At least one of first and second passageway ends 72 and 74 preferably protrude from cavity regions 82 and 84 of mold pattern 80, but may alternatively protrude from, or be embedded in, barrel body 54. In embodiments in which at least one of first and second passageway ends 72 and 74 does not protrude from mold pattern 80 or cavity regions 82 and 84, machining may be required to form fluid flow ports by removing portions of cast metal from barrel body 54 or first and second flanges 86 and 88. The fluid flow ports are preferably machined for fitting the required adaptation to suitable heat-exchanger fittings (not shown).

Casting mold 80 further includes a barrel opening region 90 that is surrounded by the interior region and that corresponds to barrel opening 62 of barrel body 54 after its formation. The filling of casting mold 80 with molten metal forms barrel opening 62 in barrel body 54 in cast metal form. Barrel opening 62 is preferably elliptical (as shown in FIG. 2A) to accommodate two meshing extrusion screws. Barrel opening 62 is preferably formed to approximate size and shape by casting and then formed to a finished size and shape by machining and/or inserting an accurately sized “figure-8” sleeve. Of course, the barrel could be cast without barrel opening region 90, or cast with a figure-8 shaped region.

FIG. 6 shows cast extruder barrel 50 of this invention with the upper half of the barrel body 54 and flanges 86 and 88 cut away to reveal heat-exchanger coil 70 integrally encapsulated within cast barrel body 54. In this view, first and second passageway ends 72 and 74 protrude from respective flanges 86 and 88. This invention is advantageous because the helical passages formed by coil 70 allow co- or counter-flow heat-exchanging while reducing the manufacturing cost of extruder barrel 50. The heat-exchanging may include heating, cooling, or both. Holes 94 machined through flanges 86 and 88 allow multiple ones of extruder barrel 50 to be attached together to form an extended-length extruder barrel having low cost and superior heat-exchanging capabilities.

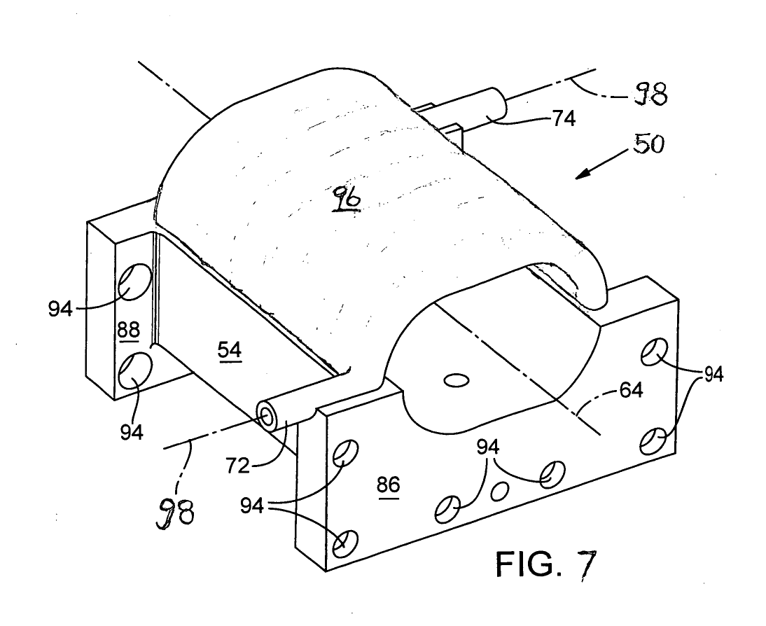

FIG. 7 shows a first alternative embodiment of cast extruder barrel 50 of this invention with the upper half of the barrel body 54 and flanges 86 and 88 cut away to reveal a heat-exchanger fluid casing 96 integrally encapsulated within cast barrel body 54. Fluid casing 96 is a generally annular, elongated opening within barrel body 54 that performs more efficient heat-exchange than conventional, externally mounted water jackets. In FIG. 7, first and second passageway ends 72 and 74 protrude from respective flanges 86 and 88. First and second passageway ends 72 have longitudinal axes 98. Heat-exchanger fluid casing 96 may include ribs (not shown) for structurally reinforcing surrounding barrel body 54. As with the above-described preferred embodiment of cast extruder barrel 50, the heat-exchanging may include heating, cooling, or both, and holes 94 machined through flanges 86 and 88 allow multiple ones of extruder barrel 50 to be attached together to form an extended-length extruder barrel having low cost and superior heat-exchanging capabilities.

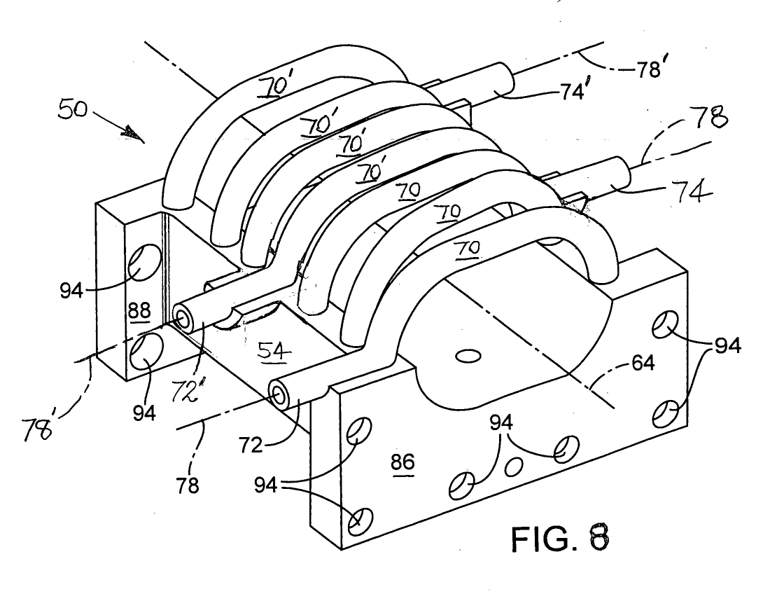

FIG. 8 shows a second alternative embodiment of cast extruder barrel 50 of this invention with the upper half of the barrel body 54 and flanges 86 and 88 cut away to reveal first and second heat-exchanger coils 70 and 70′ integrally encapsulated within cast barrel body 54. (Two heat-exchangers are shown, but employing more than two is possible.) Coils 70 and 70′ represent two fluid-passageway portions that together form a fluid flow passageway system that extends along the length of barrel body 54. Coil 70 includes first and second passageway ends 72 and 74, and coil 70′ includes first and second passageway ends 72′ and 74′. Passageway ends 72 and 74′ protrude from respective flanges 86 and 88, whereas passageway ends 72′ and 74 protrude from cast barrel body 54. Passageway ends 72 and 74 have respective longitudinal axes 78, and passageway ends 72′ and 74′ have respective longitudinal axes 78′. In this embodiment of cast extruder barrel 50, the heat-exchanging may employ coil 70 for heating, coil 70′ for cooling, or both coils for heating and/or cooling, and holes 94 machined through flanges 86 and 88 allow multiple ones of extruder barrel 50 to be attached together to form an extended-length extruder barrel having low cost and superior heat-exchanging capabilities.

Skilled workers will recognize that portions of this invention may be implemented differently from the implementation described above for preferred embodiments. For example, the extruder barrel may be adapted to various designs including solid, segmented, and clamshell, and having a barrel opening of bimetallic, treated, or sleeved design configured for single or multiple screws. Different heat-exchanger passage designs may be employed including oval, circular, annular, elongated, jacketed, or rectangular, with ends that do or do not protrude from the barrel body or flanges. More than one heat-exchanger passage may be configured to fit within a single extruder barrel, and the heat-exchangers may be of different configurations, such as a mix of coils and casings. The heat-exchanger passage ends may be adapted to connect fluid flow between mating end faces of adjacent barrel segments. The extruder barrel may be cast from a wide variety of materials and material states, such as heat treated, as cast, and consolidated. Of course, the casting of encapsulated heat-exchanger passages could be applied to various articles of manufacture, such as melt pump housings.

It will be obvious to those having skill in the art that many changes may be made to the details of the above-described preferred embodiments without departing from the underlying principles of the invention. The scope of the present invention should, therefore, be determined only by the following claims.

1. An extruder barrel constructed to have an integral internal fluid flow passageway, comprising:
a barrel body having first and second body end faces separated by a distance that defines a length of the barrel body;
a barrel opening formed in and through the barrel body along a longitudinal axis extending between the first and second body end faces;
a heat-exchanger fluid flow passageway located in the interior of the barrel body and having first and second passageway ends; and
the first and second passageway ends terminating at or near the first and second body end faces to form entrance and exit ports of the extruder barrel.

2. The extruder barrel of claim 1, in which the fluid flow passageway includes a passageway longitudinal axis that loops as a continuous spiral about the longitudinal axis and extends along the length of the barrel body.

3. The extruder barrel of claim 1, in which the fluid flow passageway comprises one or more fluid flow passageway portions located in the interior of the barrel body, and at least one of the fluid flow passageway portions comprises a tubular heat-exchanger coil that is encapsulated within the barrel body.

4. The extruder barrel of claim 3, in which the barrel body is formed of cast metal.

5. The extruder barrel of claim 3, in which there are two tubular heat-exchanger coils and each of them has an end that terminates in the barrel body before reaching one of the first and second body end faces.

6. The extruder barrel of claim 3, in which there are two tubular heat-exchanger coils and each of them has first and second ends that terminate in the barrel body before reaching the first and second body end faces.

7. The extruder barrel of claim 1, in which the fluid flow passageway defines a flow pattern in the form of interconnected alternating straight and curved segments.

8. The extruder barrel of claim 1, in which the fluid flow passageway comprises one or more fluid flow passageways located in the interior of the barrel body, and at least one of the fluid flow passageways comprises an elongated annular heat-exchanger casing that is encapsulated within the barrel body.

9. The extruder barrel of claim 1, in which the barrel opening is of sufficient size to receive at least one extruding screw positioned substantially parallel to the longitudinal axis.

10. The extruder barrel of claim 1, in which the barrel body is one of solid design or clam shell design.

11. The extruder barrel of claim 1, in which the first and second body end faces of the barrel body are configured to form a connectible barrel segment.

12. A method of making an extruder barrel having an integral internal heat-exchanger system, comprising:
providing a heat-exchanger fluid flow passageway device having a longitudinal axis;
providing a metal casting mold patterned to form an extruder barrel body, the metal casting mold formed with an interior region corresponding to a solid interior region of the extruder barrel body after its formation;
positioning the heat-exchanger fluid flow passageway device in the metal casting mold, the heat-exchanger device having opposed terminal ends and, when positioned in the mold, resting in the interior region corresponding to a solid interior region of the extruder barrel body;
filling the mold with molten metal, the molten metal flowing around the heat-exchanger device and thereby encapsulating it in the solid interior region of the extruder barrel body; and
removing the mold to expose the extruder barrel body in cast metal form.

13. The method of claim 12, in which the heat-exchanger fluid flow passageway device comprises one or more heat-exchanger fluid flow devices, at least one of which comprises a coil in the form of a continuous spiral.

14. The method of claim 12, further comprising machining the extruder barrel body to form fluid flow ports for the terminal ends of at least one of the heat-exchanger fluid flow passageway devices.

15. The method of claim 14, in which:
the extruder barrel body has first and second body end faces;
the terminal ends of at least one of the encapsulated heat-exchanger fluid flow devices do not connect to the first and second body end faces; and
the machining to form fluid flow ports includes removing portions of cast metal from the extruder barrel body to form passageways that connect the first and second body end faces to one or more of the terminal ends.

16. The method of claim 12, in which the metal casting mold formed with an interior region corresponding to a solid interior region further comprises a barrel opening region that is surrounded by the interior region and that corresponds to a barrel opening of the extruder barrel body after its formation, and in which the filling of the mold with molten metal forms a barrel opening in the extruder barrel body in cast metal form.

17. The method of claim 12, in which the extruder barrel is cast by employing a near net casting process or a lost wax casting process.

18. An extruder barrel constructed to have an integral internal fluid flow passageway, comprising:
a cast barrel body having first and second body end faces separated by a distance that defines a length of the cast barrel body;
a barrel opening formed in and through the cast barrel body along a longitudinal axis extending between the first and second body end faces;
a heat-exchanger fluid flow passageway located in the interior of the cast barrel body and having first and second passageway ends; and
the first and second passageway ends terminating at or near the first and second body end faces to form entrance and exit ports of the extruder barrel.

19. The extruder barrel of claim 18, in which the fluid flow passageway comprises one or more fluid flow passageway portions located in the interior of the cast barrel body, and at least one of the fluid flow passageway portions comprises a tubular heat-exchanger coil that is encapsulated within the cast barrel body.

20. The extruder barrel of claim 18, in which the fluid flow passageway comprises one or more fluid flow passageways located in the interior of the cast barrel body, and at least one of the fluid flow passageways comprises an elongated annular heat-exchanger casing that is encapsulated within the cast barrel body.

21. The extruder barrel of claim 18, in which the cast barrel body is one of a solid or a clam shell design.

22. The extruder barrel of claim 18, in which the cast barrel body is formed of multiple types of metal.
